(19) United States
(12) Patent Application Publication
(10) Pub. No.: US 2024/0281768 A1
(43) Pub. Date: Aug. 22, 2024

(54) SYSTEM FOR REPORTING PRECISE REAL-TIME MARKET COMPENSATION DATA, USING NOVEL HYBRID AI TRANSFORMATIONS, EXPONENTIAL DATA CAPTURE AND ADVANCED MACHINE LEARNING STRATEGIES

(71) Applicant: Richard Alexander Lear, Lyons, CO (US)

(72) Inventor: Richard Alexander Lear, Lyons, CO (US)

(21) Appl. No.: 18/640,244

(22) Filed: Apr. 19, 2024

Related U.S. Application Data
(60) Provisional application No. 63/446,882, filed on Feb. 19, 2023.

(51) Int. Cl. G06Q 10/1053

(52) U.S. Cl. CPC G06Q 10/1053

(57) ABSTRACT

A system and method provide automated retrieval of employment compensation data related to a job position of interest from one or more sources of employment with the same or a similar position. Embodiments generate a compensation value based on the retrieved data. The pay range and salary estimate at other companies, and in other regions, for the same position may be determined using the search for a particular position in one company or region.

### CROSS-REFERENCE TO RELATED APPLICATION

This non-provisional patent application claims the benefit of U.S. Provisional Application No. 63/446,882, entitled, “SYSTEM FOR CORPORATE COMPENSATION MARKET DATA APPLICATIONS,” filed on Feb. 19, 2023, the contents of which are incorporated herein by reference as if set forth in full and priority to this application is claimed to the full extent allowable under U.S. law and regulations.

### BACKGROUND

The embodiments herein relate generally to online data processing systems, and more particularly, to a system for corporate compensation market data applications.

Pay transparency laws have opened the door for new compensation products. As companies reveal their compensation ranges for a specific position, they also reveal something about their pay philosophy.

Conventional compensation tools are typically based on salary surveys or job websites. Salary surveys are only available to companies. Job websites use unverified compensation data. New laws require companies to state actual pay ranges, therefore a new level of transparency is needed that currently no other compensation solution has had access to.

### SUMMARY

In one aspect of the subject technology, a system and method provide automated retrieval of employment compensation data related to a job position of interest from one or more sources of employment with the same or a similar position. Embodiments generate a compensation value based on the retrieved data. The pay range and salary estimate at other companies, and in other regions, for the same position may be determined using the search for a particular position in one company or region.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE FIGURES

The detailed description of some embodiments of the invention is made below with reference to the accompanying figures, wherein like numerals represent corresponding parts of the figures.

FIGS. 1A and 1B are a flowchart for a process of generating a compensation value for a job position according to an embodiment of the subject technology.

FIG. 2 is a screenshot of a user interface for locating a compensation value for a position according to an embodiment of the subject technology.

FIG. 3 is a screenshot of a user interface for looking up company information according to an embodiment of the subject technology.

FIGS. 4-6 show a process for capturing data and calculating baseline values according to an exemplary embodiment.

FIG. 7 is a screenshot of a UX design for a user interface that displays values generated for one or more processes of the subject technology according to an exemplary embodiment.

### DETAILED DESCRIPTION OF CERTAIN EMBODIMENTS

In order to create precision and accuracy in modeling and reporting real-time compensation data built on sparse datasets, the following key challenges should be addressed.
achieving equivalencies to statistical significance of predicted outcomes where the size of datasets is constrained by currently available data.

Translation and enrichment of incomplete datasets, where predictive factors are missing or ambiguously labeled.

Extending coverage of predictive data through novel extrapolation and/or interpolation strategies.

Deploying optimal machine learning models built on real-world derived frameworks, postulated by human expertise.

This description addresses the processes and novel approaches to delivering precision, robust scale, marketplace integrity, exponential extensions and instantaneous learning for real-time compensation applications built on sparse datasets.

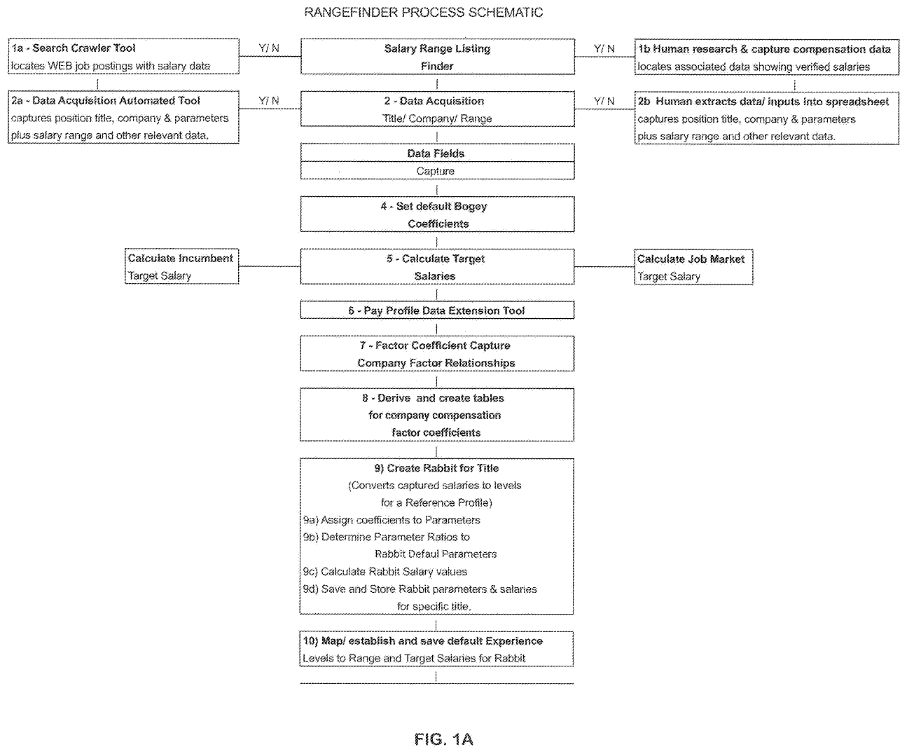

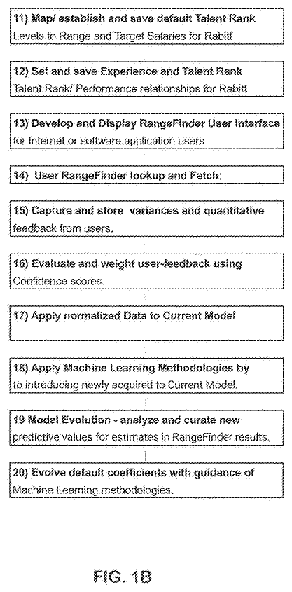

In general, embodiments of the disclosed subject technology provide a system that captures, models and displays highly accurate corporate compensation market data based on using and applying artificial intelligence to verified pay ranges. In one embodiment, a process uses automated computerized tools to search job websites and other public sources to gather information about compensation ranges for specific positions at specific companies. That data will then be captured, stored and collated in data repositories for retrieval, analysis, interpretation, extrapolation and future publication in a searchable, automated system. The baseline process (which can be seen in FIGS. 1A and 1B) may utilize various mathematical algorithms and artificial intelligence methodologies applied to salary ranges for titles at a particular company in a particular location with a minimum experience to enable the following innovations:

Calculate and display estimates for target salaries for 1) hiring in the current job market and 2) optimally paying incumbent employees.

Estimate pay ranges and target salaries for the same title at more than 16,500 companies in at least 21 different regions.

Estimate pay ranges and target salaries based on acquired verified salary ranges for a given title, using company parameters such as industry (market space), funding stage, size (revenue/# employees), company pay philosophy and company valuation among others.

Calculate and display different target salaries based on different metrics for employee experience, performance, and/or candidate quality.

Allows users to provide quantitative feedback on the estimated values for salary ranges and target salaries. The system will use that feedback to apply machine learning and other analytics that can improve accuracy of those estimates.

An algorithm will then be applied to each pay profile captured. A pay profile includes the title (role), company, location and multiple other parameters, plus actual data listed for both the high and low levels of the salary ranges published. The term “role” and “title” may be interchangeable and can be defined as a combination of level and function for a specific title. Also, in the description below, a name given to the system is “RangeFinder” however it will be understood that embodiments of the system may use a different name than the present label.

### Key Innovation: the Rabbit—the Reference Profile

A key feature of RangeFinder entails the system utilizing market compensation model called TalentValue. This model is a mathematically-derived compensation model built on various factors that influence compensation. Key components of the current model are described below. It currently incorporates more than 15 factors, which are quantitatively modeled. The model recognizes relationships between companies, funding stages, company size, location of the role, industries and corporate pay philosophy and elements of the role/title itself. The algorithm converts the captured data for a single pay profile, which includes title, company, location and its associated parameters and salary ranges—to a reference profile for this title. This reference profile, we call the “Rabbit”, which is defined by a consistent set of profile parameters like company size, funding stage, location, industry (or market space), will serve as a comparison profile for user requested permutations of the basic Title/role. The algorithm converts the salary range of the captured pay profile into a standardized salary range based on a predetermined set of parameters to establish a Rabbit for each title. While the name “Rabbit” is used, it will be understood that other names may be given to the reference profile.

When users of the searchable system seek salary ranges for a specific title, which specifies parameters different from the initial captured pay profile, or the Rabbit itself, the system will use the Rabbit ranges to convert to the parameters of the requested profile using coefficient relationships. The result is an estimate for salary ranges.

### Exponential Impact of Data Acquisition

Thus, when the system captures one pay profile, showing the verified salary range for a specific title, company and location; and a Rabbit is then established, the system will immediately be able to calculate and display estimates for hundreds of thousands of permutations of parameters related to that title/role. For example, based on a single acquisition of a pay profile, RangeFinder will be able to respond to requests for the same title at 16,500 companies in 21 different locations. As each company is defined by an industry (marketspace), funding stage, revenues, employee size, valuation and headquarters location, the minimum number of estimated pay profiles generated by a single new acquisition of title, company and location is 346,500 (16,500 companies×21 locations).

### Searchable Tool by Company or Company Parameters Only

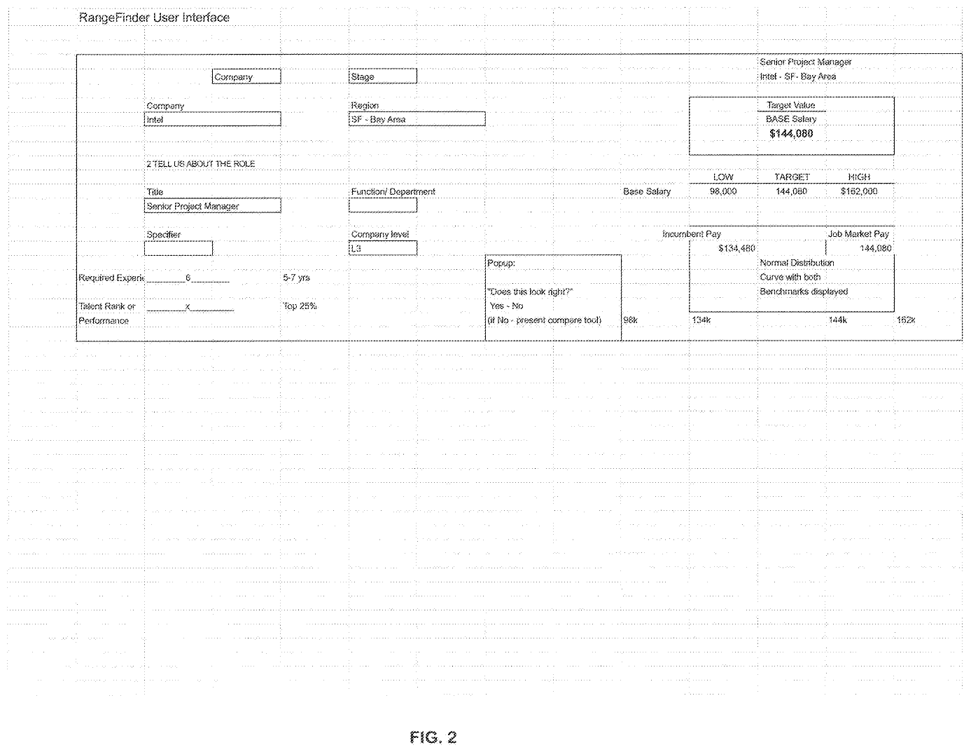

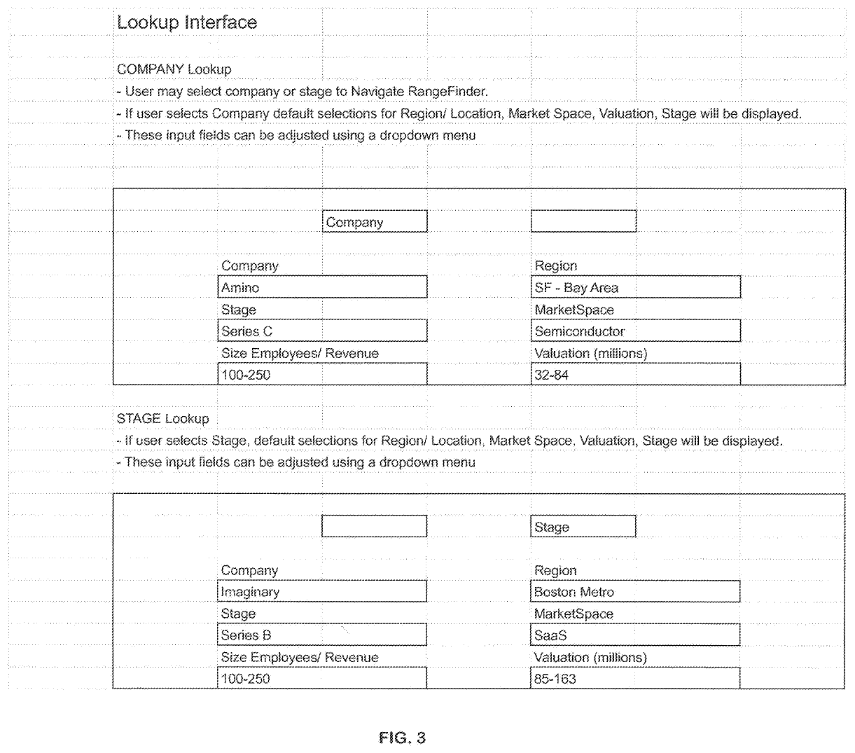

FIGS. 2 and 3 show user interfaces for initiating searches. The searchable, automated system will also allow users to search pay ranges by parameters only. For instance, instead of users simply specifying a company, the user can use company parameters along with a given title to generate salary ranges for data not directly captured by RangeFinder. In one example (the following numbers in parentheses represent the number of options for a parameter), users of the system may search titles by specifying a given menu choice for funding stage (10), location (21), industry or marketspace (44), revenues (10), valuation (12), and # of employees (10). The number of possible combinations to search by parameter currently stands at 11,088; but likely will increase over time.

### Target Salaries for the Job Market or Incumbent Employees

The system will also uniquely create target pay metrics for multiple compensation benchmarks. For instance, the initial version of RangeFinder calculates and displays target salaries for both 1) the current job market benchmark and another for the 2) target salary of incumbent employees. RangeFinder will use a combination of expert-driven formulas and machine learning to peg what levels companies will likely pay new hires—in today's job market. Separately, the system will calculate and display what incumbent employees-employees in the current role, will likely be paid, given the verified salary ranges.

RangeFinder will also discover and acquire user feedback as to the accuracy of estimated pay ranges and estimates for target salaries for the job market and incumbent pay. This feedback will be first curated, credibility of the feedback established and then weighted values based on ‘confidence’ metrics will be processed. New input will be incorporated into the model. Then this new data will be added to machine learning models, which can improve estimates of the system, increasing accuracy of all estimates.

Performance and employee Quality

This system will include performance and experience metrics, which provides a further level of filtering and calibration for salary levels for any given title. The system will provide at least 45 distinct levels of performance or employee quality. The user feature is called Talent Rank, which will be used for companies and professionals. The feature for employees and job candidates will be called performance and allow 4 distinct levels of performance to be divided into multiple subcategories for more granularity. Compensation percentile units can be used as a substitute for either measurement system.

### Experience

Finally, the system will establish and evolve target experience levels for each Title—pay profile captured. Also default experience ranges will be set to link with salary ranges to reflect the impact of actual experience on salary levels. The system of assigning target experience levels and correlating low and high experience levels with low and high salary levels will establish a fundamental framework of users to most effectively describe the relevant characteristics of the employee or job candidate being modeled.

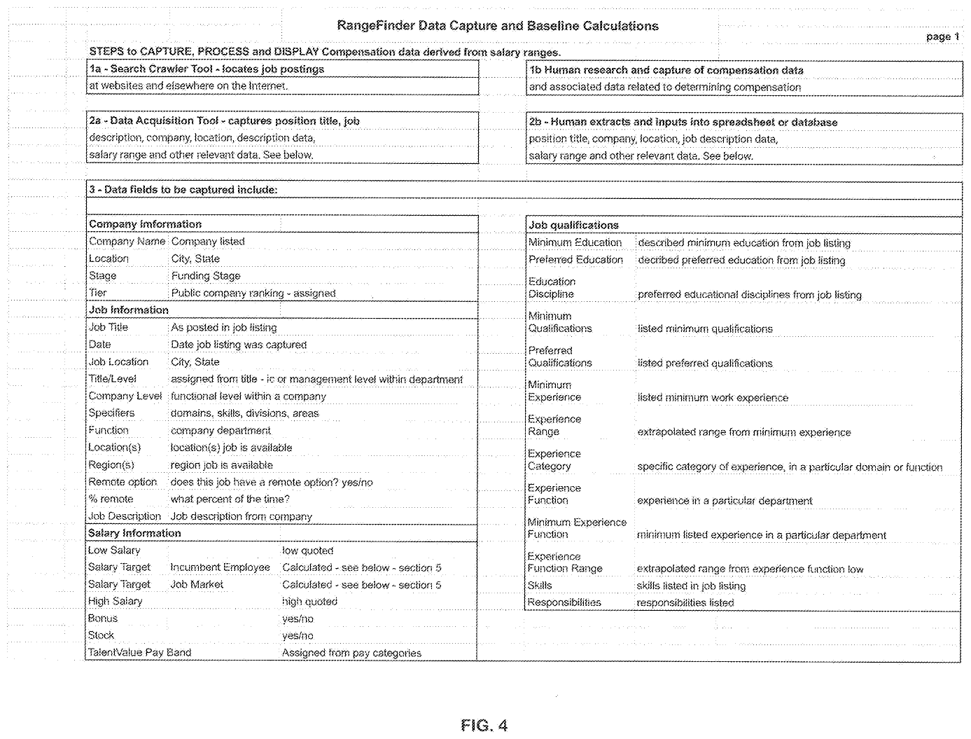

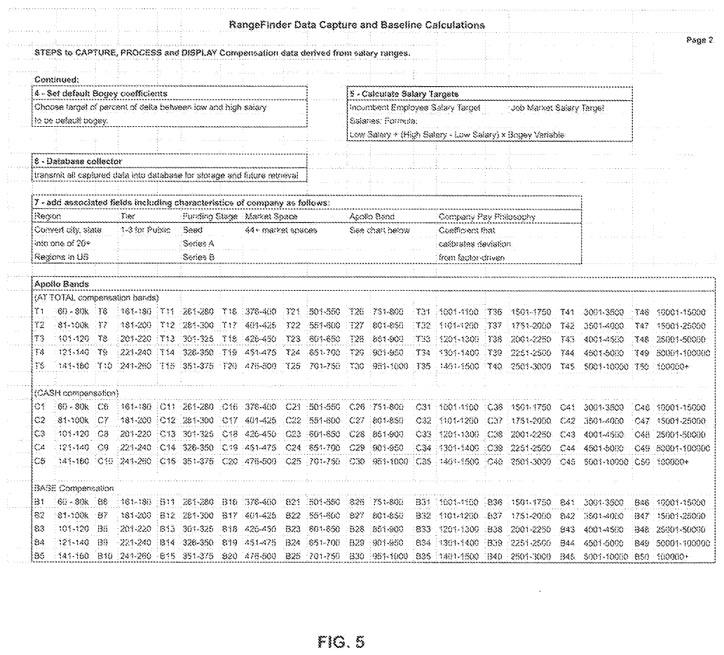

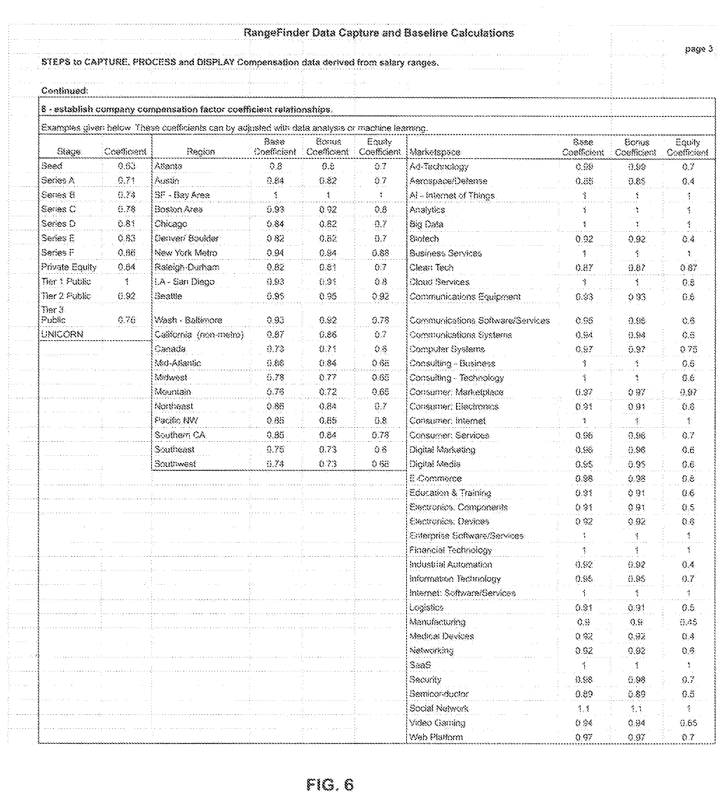

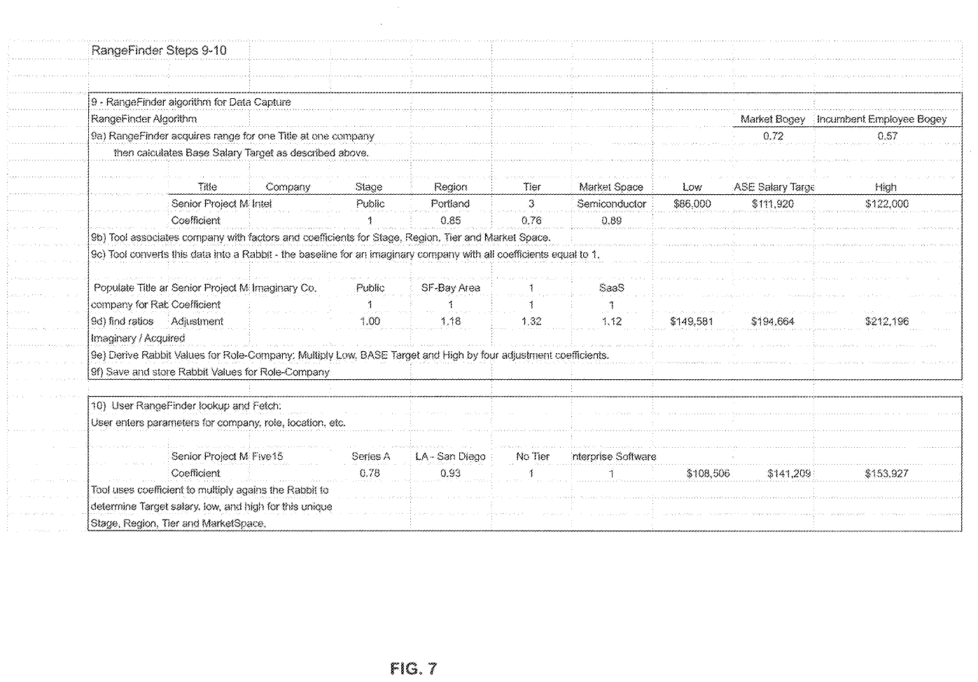

FIGS. 1A-1B and 4-7 show a process according to one embodiment. The blocks referenced in the following description refer to the number labels that can be seen embedded in the boxes within the flow.

For example, in step 1, Salary Range Listing Finder: Block 1a) is a Search Crawler tool: locates specific titles and websites which display salary ranges. Block 1b) represents Human Research & capture compensation data. These features locate associated data showing verified salaries on job websites, or company websites.

Block 2 is a Data Acquisition Tool, which extracts data relevant to publishing. Establish a unique pay profile for Title, Company and location. Pay Profile below.

Block 3 is a Data Fields Capture interface-a database collector that looks to retrieve data based on the input within the fields. Transfer all information for pay profile into a secure database for processing.

Block 4 is a Set default Bogey Coefficients for Target Salaries field. Initially, default values will be adopted to calculate estimated target salaries. The bogey is the percentage of the difference between high and low salaries captured. The initial bogey variable will be 0.72 for the Target Salary for today's job market and 0.57 for the Target Incumbent employee salary. Using data analysis and machine learning methodologies. (i.e. Bayesian Machine Learning), these values will adjust over time based on user feedback and additional verified salaries. These values may be title-dependent and require multiple values for each, depending on the title, company or other factors.

Block 5 is a field to Calculate Target Salaries. Estimated target salaries are calculated for 1) Today's Job Market; 2) Incumbent Employee. The calculation:

Formula: Low Salary+(High Salary−Low Salary)×Bogey Variable

Example: Job Market Target: $106,000+($165,000−$106,000)×0.72=$148,480.

Block 6 is a Pay Profile data extension tool, which establishes extended data for unique pay profiles and add to data Structures for all company parameters (factors) and data. Convert data into usable formats and factors. Link system of compensation bands to unique pay profile. In corporate companies pay philosophy using a coefficient multiplier based on previous company pay tendencies and/or comparisons with like company/title/location pay profiles.

Block 7 is a set of input fields for establishing and inserting Company Factor Relationships. Using derived coefficient relationships to a chosen baseline factor value, translate parameter labels to numerical values for unique pay profile. The table underneath Block 7 shows an example of Company Compensation Factor Coefficients. These coefficients will be adjusted over time using advanced analytics and machine learning techniques. Additional company factors will be adopted in the future.

Block 8 is an interface that derives and creates a table for Company Factor (parameter) compensation coefficients for unique pay profile, using the table associated with Block 7. Parameter coefficients may be linked to acquired, unique pay profile parameters.

Block 9 represents an algorithm for determining compensation and other data for a job title. In one step, a Rabbit is created for a specific Title. The Rabbit is a reference profile for a specific Title. It assumes a standardized factor profile for a title, which includes funding stage of Public, region of SF-Bay Area, Tier level 1 for public companies, Saas for Market Space and standard pay philosophy coefficients. All Rabbit coefficients are normalized to 1.

In sub-step 9a, coefficients are assigned to parameters.

In sub-step 9b, Rabbit Values (factor ratios) to Rabbit default parameters may be determined. Divide each benchmark coefficient (1) by acquired pay profile factor coefficient.

In sub-step 9c, Rabbit salary values are calculated for a unique pay profile. Salaries are adjusted by multiplying derived Rabbit values by salaries for acquired pay profile.

In sub-step 9d, Rabbit data and salaries for specific title, company and location are stored.

In block 10, the system may store the previous parameters as a default experience (for example, as an auto-fill for a user returning to the UI). Blocks 11-20 include additional steps that are labeled with self-explanatory descriptions.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “engine”, or “system.” Furthermore, aspects of the disclosed invention may take the form of a computer program product embodied in one or more computer readable media having computer readable program code embodied thereon. In some embodiments, the output of the computer program product provides an electronic user interface on the display.

Aspects of the disclosed invention are described above with reference to block diagrams of methods, apparatuses, systems and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks in the figures.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

What is claimed is:

1. A system for automated generation of market compensation values for a position, comprising:
an input module for receiving, from a user, a query identifying a job position of interest; and
a processing platform operative for automatically retrieving employment compensation data related to said job position of interest from one or more sources of employment compensation data including data for the same or a similar position, generating a compensation value based on the retrieved data; using said compensation value in providing a response to said query.

2. An automated process for determining the compensation value for a position, comprising:
receiving, from a user, a query identifying a job position of interest; and
operating a processing platform for automatically retrieving employment compensation data related to said job position of interest from one or more sources of employment compensation data including data for the same or a similar position, generating a compensation value based on the retrieved data; using said compensation value in providing a response to said query.

3. A user interface for generation of market compensation values for a position, as disclosed herein.
